(19) United States
(12) Patent Application Publication
(10) Pub. No.: US 2010/0271338 A1
(43) Pub. Date: Oct. 28, 2010

(54) INPUT APPARATUS WITH FLEXIBLE INPUT PANEL

(75) Inventor: SHAN-FU HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/693,506

(22) Filed: Jan. 26, 2010

(30) Foreign Application Priority Data
Apr. 24, 2009 (CN) 200910301802.5

(51) Int. Cl. G09G 5/00; G06F 3/033

(52) U.S. Cl. 345/179; 345/156

(57) ABSTRACT

An exemplary input apparatus, includes a flexible input panel, a reel, a stylus and an image capturing apparatus. The reel includes a casing and a rotatable spindle, the casing defining an inner space and an opening communicating the inner space, the rotatable spindle being received in the inner space and configured for winding the input panel into the inner space of the casing and unwinding the input panel out of the casing through the opening. The stylus is configured for input information to the input panel. The image capturing apparatus is mounted on the casing and configured for obtaining the information inputted to the input panel by the stylus.

### BACKGROUND

1. Technical Field

The present disclosure relates to input apparatuses, and particularly, to an input apparatus having a flexible input panel.

2. Description of Related Art

Input apparatuses are important for electronic device. Such input apparatuses may be connected to the electronic device by wire or by wireless infrared light.

A typical input apparatus includes an input panel. The input panel may be in a broad shape. Information, such as numbers, letters or touch may be inputted to the input panel by a stylus or by user's finger.

However, generally, the input panel is rigid, and cannot be folded, thus resulting inconvenience to carry it and protect it.

What is needed, therefore, is an input apparatus which can overcome the above shortcomings.

### BRIEF DESCRIPTION OF THE DRAWINGS

Many aspects of the present input apparatus can be better understood with reference to the following drawings. The components in the drawings are not necessarily drawn to scale, the emphasis instead being placed upon clearly illustrating the principles of the present input apparatus. Moreover, in the drawings, like reference numerals designate corresponding parts throughout the several views.

FIG. 1 is a schematic view of an input apparatus in accordance with an embodiment, showing a flexible input panel released out of a casing of a reel of the input apparatus, and a stylus contacting the input panel.

FIG. 2 is similar to FIG. 1, but showing the input panel wound in the casing of the reel.

FIG. 3 is a cross-sectional view of the reel.

### DETAILED DESCRIPTION

Embodiment of the present input apparatus will now be described in detail below and with reference to the drawings.

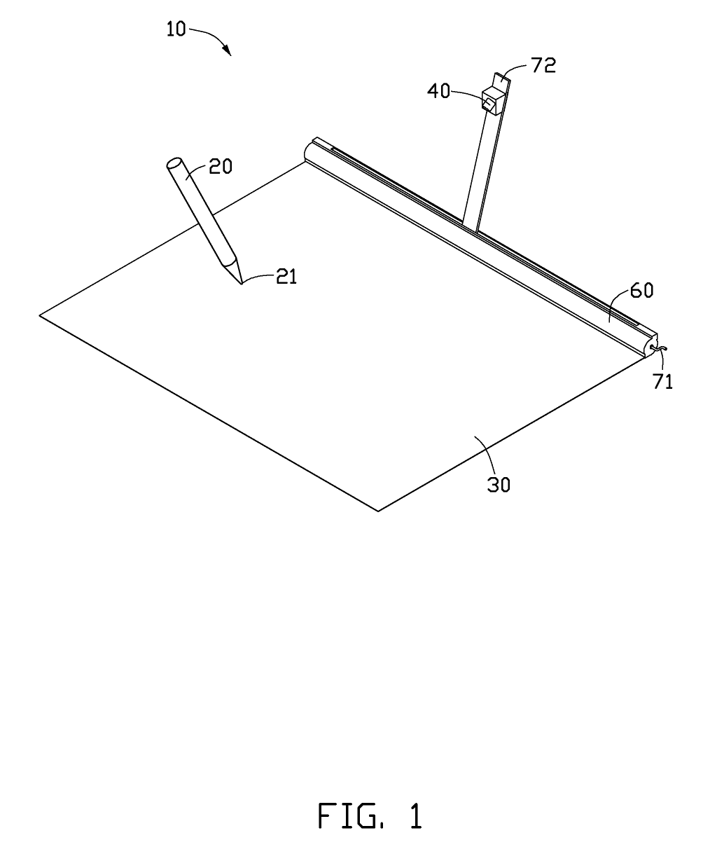

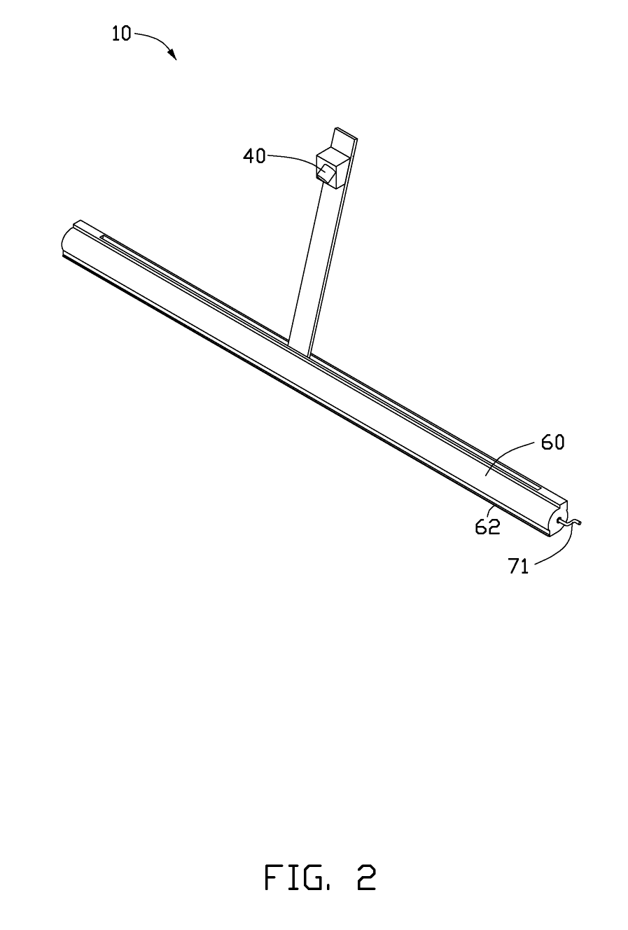

Referring to FIGS. 1 to 3, an input apparatus 10 in accordance with an embodiment, is shown. The input apparatus 10 includes a flexible input panel 30, a reel 50, a pole 72, an image capturing apparatus 40, and a stylus 20. The image capturing apparatus 40 can be connected to a display of an electronic device (not shown) by wire or by wireless infrared light.

The input panel 30 is made of flexible materials, such as plastic, cotton, or paper, thereby the input panel 30 is flexible. A size of the input panel 70 can be the same as a displaying area of a display connected by the input apparatus 10. The input panel 70 has a light color, such as white, thus the input panel 30 reflects light and the information inputted to the input panel 70 is legible. Preferably, a refractive index of the input panel 30 is not less than 0.7. The stylus 20 imprints the input panel 30 when it contacts the input panel 30, thereby input information to the input panel. In the present embodiment, a tip 21 of the stylus 20 is capable of emitting infrared light, and a refractive index of the input panel 30 to the infrared light is not less than 0.7.

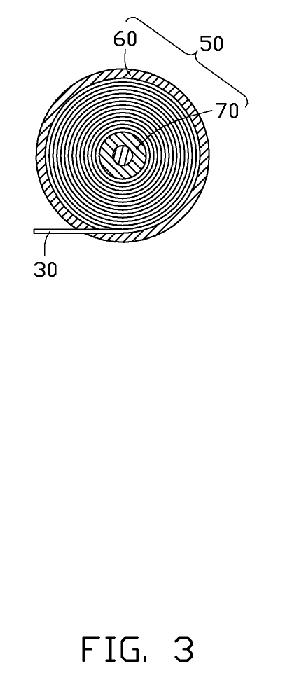

The reel 50 includes a casing 60 and a rotatable spindle 70. The casing 60 defines a tubular inner space (see FIG. 3), and an opening 62 communicating with the inner space. In the present embodiment, the outer shape and the inner space of the casing 60 are both cylindrical. The rotatable spindle 70 is received in the inner space of the casing 60, and has a handle 71 extending out of the casing 60. The flexible input panel 30 has an end connected to the rotatable spindle 70, and can be wound (see FIG. 3) in the inner space of the casing 60 or unwound (see FIG. 1) out of the casing 60 through the opening 62 by rotating the handle 71 correspondingly.

The pole 72 is positioned on the casing 60, by fixedly positioned thereon or rotatably positioned thereon The image capturing apparatus 40 is supported by the pole 72, and can capture images of the information inputted to the input panel 30. In the present embodiment, the image capturing apparatus 40 can be an infrared (IR) image capturing apparatus 40, and can only receive the infrared light emitted by the tip 21 of the stylus 20.

In application, when the stylus 20 inputs information to the input panel 30, the image capturing apparatus 40 can receive the infrared light emitted by the tip of the stylus 20, thus obtaining a location of the tip or movement of the tip on the input panel 30 in real time, thereby obtaining the information inputted to the input panel 30. The image capturing apparatus 40 can then transmit signals of the images to the electronic device, and the display of the electronic device then give response to and display the information.

In some GUIs, when not text input is required, the image capturing apparatus 40 only needs to obtain the position of the input action relative to the entire input panel 30. It is understood that, in these cases, other stylus or touch can perform the input instead of the stylus 20.

In other embodiments, the image capturing apparatus can capture images of the information inputted to the input panel 30 directly. In these cases, an IR-cut filter is preferably used in the image capturing apparatus.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An input apparatus, comprising:
a flexible input panel; and
a reel comprising a casing and a rotatable spindle, the casing defining a tubular inner space and an opening communicating the inner space, the rotatable spindle being received in the inner space and configured for winding the input panel thereon so as to cause the wound input panel to be received in the inner space and unwinding the wound input panel to cause the unwound input panel to extend out of the inner space through the opening.

2. The input apparatus as described in claim 1, wherein the rotatable spindle has a handle extending out of the casing.

3. The input apparatus as described in claim 1, wherein the inner space is cylindrical.

4. The input apparatus as described in claim 1, further comprising an image capturing apparatus, the reel further comprising a pole positioned on the casing, and the pole configured for supporting the image capturing apparatus.

5. The input apparatus as described in claim 1, wherein a refractive index of the input panel is not less than 0.7.

6. An input apparatus, comprising:
a flexible input panel;
a reel comprising a casing and a rotatable spindle, the casing defining an inner space and an opening communicating the inner space, the rotatable spindle being received in the inner space and configured for winding the input panel thereon to cause the wound input panel to be received in the inner space of the casing and releasing the wound input panel out of the casing through the opening;
a stylus configured for input information to the input panel; and
an image capturing apparatus mounted on the casing and configured for obtaining the information inputted to the input panel by the stylus.

7. The input apparatus as described in claim 6, wherein the rotatable spindle has a handle extending out of the casing.

8. The input apparatus as described in claim 6, wherein the inner space is cylindrical.

9. The input apparatus as described in claim 6, wherein the reel further comprises a pole positioned on the casing, the image capturing apparatus is supported by the pole.

10. The input apparatus as described in claim 6, wherein a tip of the stylus is capable of emitting infrared light, and the image capturing apparatus configured for capturing infrared images of the tip, thereby obtaining the information inputted to the input panel based on location of the tip or movement of the tip on the input panel.

11. The input apparatus as described in claim 10, wherein a refractive index of the input panel to the infrared light is not less than 0.7.

12. An input apparatus, comprising:
a flexible input panel;
a reel comprising a casing and a rotatable spindle, the casing defining an inner space and an opening communicating the inner space, the rotatable spindle being received in the inner space and configured for winding the input panel into the inner space of the casing and unwinding the input panel out of the casing through the opening; and
an image capturing apparatus supported by the casing and configured for capturing images of the information inputted to the input panel.
